(19) United States
(12) Patent Application Publication
(10) Pub. No.: US 2008/0117197 A1
(43) Pub. Date: May 22, 2008

(54) Plasma display panel and apparatus and method of driving the same

(76) Inventor: Donghyun Kim, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/818,138

(22) Filed: Jun. 12, 2007

(30) Foreign Application Priority Data
Nov. 22, 2006 (KR) 10-2006-0116048

(51) Int. Cl. G09G 3/28; G09G 5/00

(52) U.S. Cl. 345/212; 345/204; 345/67

(57) ABSTRACT

Disclosed are a plasma display panel, a apparatus and apparatus for driving the same. The plasma display panel includes a front substrate and a rear substrate that are oppositely arranged to each other, a scan electrode and a sustain electrode formed on the front substrate including a transparent electrode and a bus electrode, an address electrode formed on the rear substrate in a direction that is intersected with the scan electrode and the sustain electrode, and a barrier rib that is arranged in space between the front substrate and the rear substrate so as to form a plurality of discharge cells, wherein the ratio of a net area (S_{T}) of the transparent electrode that transmits a visible ray among the whole area of the transparent electrode against an area (Sc) of the discharge cell is satisfied by the equation:

0.51≦S_{T}/S_{C}≦0.83

### CROSS-REFERENCE TO RELATED APPLICATIONS

This application claims priority to and the benefit of Korean Patent Application No. 10-2006-0116048, filed on Nov. 22, 2006, the entire content of which is incorporated herein by reference.

### BACKGROUND OF THE INVENTION

1. Field of the Invention

The present embodiments relate to a plasma display device and a driving method thereof, and more particularity, to a plasma display panel and an apparatus and a method of driving the same which can increase display ability of low gray-level and improve efficiency.

2. Description of the Related Art

A plasma display device is a display device for displaying a character or an image by using plasma generated by gas discharge. The plasma display device includes a plasma display panel to display the image and a plurality of driving circuits for driving the plasma display panel.

The plasma display panel includes a front panel having a scan electrode and a sustain electrode positioned on the same surface and a rear substrate having an address electrode vertically connected by being spaced by a fixed distance from the front panel. A discharge gas is filled between the front panel and the rear substrate. The plasma display panel displays a desired image by using a visible ray generated during a procedure that when electric power is inputted through electrodes, phosphor is excited by a vacuum ultraviolet rays generated by the discharge.

Recently, with high-resolution of an image media, a plasma display panel having a full high definition, that is the plasma display panel having a discharge cell pitch less than 650 μm, has been requested. The full high definition panel has efficiency (brightness ratio for power consumption) of about 20% less than a low resolution panel. Especially, the bus electrode included to the scan electrode and the sustain electrode is positioned on a visible ray emission range of a discharge cell, thereby allowing efficiency to become much lower because effective light is decreased and power consumption is increased as well. Also, if a transparent electrode connected with a bus electrode is formed too largely, because power consumption is largely increased and unit light is also increased as well, there is a problem that display ability of low gray-level is decreased. The plasma display panel of the current embodiments solves this and other problems as well.

### SUMMARY OF THE INVENTION

Accordingly, the present embodiments solve the above-mentioned problems occurring in the prior art, and an object of the present embodiments is to provide a plasma display panel and an apparatus and a method of driving the same which can increase display ability of low gray-level as well as improve efficiency.

Additional advantages, objects and features of the embodiments will be set forth in part in the description which follows and in part will become apparent to those having ordinary skill in the art upon examination of the following or may be learned from practice of the embodiments.

According to an aspect of the present embodiments, a plasma display panel includes: a front substrate and a rear substrate that are oppositely arranged to each other; a scan electrode and a sustain electrodes formed to have a transparent electrode and a bus electrode on the front substrate; an address electrode formed on the rear substrate in a direction that the scan electrode and the sustain electrode are intersected with each other; and a barrier rib arranged in space between the front substrate and the rear substrate so as to form a plurality of discharge cells. The ratio of a net area (S_{T}) of the transparent electrode that transmits a visible ray among the whole area of the transparent electrode against an area (Sc) of the discharge cell is 0.51≦S_{T}/S_{C}≦0.83.

The net area of the transparent electrode may be an area that is not overlapped with the bus electrode among the whole area of the transparent electrode.

The barrier rib may include a vertical barrier rib arranged in parallel with the address electrode; and a horizontal barrier rib arranged in a direction an orthogonal to the horizontal barrier rib and forming a space between neighboring discharge cells in an extension direction of the address electrode so as to form a non-discharge cell.

The transparent electrode may have thickness of 300 to 1000 nm.

The transparent electrode may be formed with ITO (Indium-doped Tin Oxide) or ATO (Antimony-doped Tin Oxide).

The barrier rib may be formed with a chemical compound including PbO, B₂O₃, SiO₂, and Al₂O₃.

At least one of K₂O, BaO, and ZnO is added to the barrier rib.

Mixing gases such as He—Ne—Xe is injected inside the discharge cell, and pressure of discharge gas is 360˜500Torr.

The bus electrode may be formed with an inorganic compound having Ag of 60˜80 μm line width and 3˜7 μm thickness as main ingredient.

Pitch of the discharge cell may be less than 650 μm.

According to another aspect of the present embodiments, an apparatus for driving a plasma display panel including a front substrate and a rear substrate that are oppositely arranged to each other, a scan electrode and a sustain electrodes formed to have a transparent electrode and a bus electrode on the front substrate; an address electrode formed on the rear substrate in a direction that the scan electrode and the sustain electrode are intersected to each other, and a barrier rib arranged in space between the front substrate and the rear substrate and forming a plurality of discharge cells, which includes: an scan driver for driving the scan electrode; a sustain driver for driving the sustain electrode; and an address driver for driving the address electrode, wherein the ratio of a net area (S_{T}) of the transparent electrode that transmits a visible ray among the whole area of the transparent electrode against area (Sc) of the discharge cell is 0.5≦S_{T}/S_{C}≦0.83.

According to still another aspect of the present embodiments, a method for driving a plasma display panel divided into a plurality of sub-fields, where the plasma display panel includes a front substrate and the rear substrate that are oppositely arranged to each other, a scan electrode and a sustain electrodes formed to have a transparent electrode and a bus electrode on the front substrate, an address electrode formed on the rear substrate in a direction that the scan electrode and the sustain electrode are intersected to each other; and a barrier rib arranged in space between the front substrate and the rear substrate so as to form a plurality of discharge cells, which includes; initializing the plurality of the discharge cells for a reset period of a ith subfield (here, i is natural number) among the plurality of the sub-an fields; selecting an emitting cell among the plurality of the discharge cells for an address period of the ith subfield; and sustain-discharging the emitting cell for a sustain period of the ith subfield wherein the ratio of a net area (S_{T}) of the transparent electrode that transmits a visible ray among the whole area of the transparent electrode against an area (Sc) of the discharge cell is 0.5≦S_{T}/S_{C}≦0.83.

### BRIEF DESCRIPTION OF THE DRAWINGS

The above aspects of the present embodiments will be more apparent by describing certain exemplary embodiments with reference to the accompanying drawings, in which:

FIG. 1 is a perspective view illustrating a plasma display panel according to one exemplary embodiment;

FIG. 2 is a diagram illustrating efficiency according to the ratio of a net area of a transparent electrode against an area of a discharge cell in the plasma display panel of FIG. 1;

FIG. 3 is a diagram illustrating unit light according to the ratio of the net area of a transparent electrode against the area of the discharge cell in the plasma display panel of FIG. 1;

FIG. 4 is a plain view illustrating a plasma display panel according to another exemplary embodiment;

FIG. 5 is a plain view illustrating a prior art plasma display panel compared with a plasma display panel of FIG. 4;

FIGS. 6A and 6B are plain views illustrating various exemplary embodiments on the transparent electrode of the plasma display panel according to the exemplary embodiment and the another exemplary embodiment;

FIG. 7 is a block diagram illustrating a driving apparatus of the plasma display panel according to the exemplary embodiment and the another exemplary embodiment;

FIG. 8 is a diagram illustrating an arrangement of sub-field according to the exemplary embodiment and the another exemplary embodiment; and

FIG. 9 is a diagram illustrating a driving waveform of the plasma display panel according to the exemplary embodiment and the another exemplary embodiment.

### DETAILED DESCRIPTION OF EXEMPLARY EMBODIMENTS

Hereinafter, preferred embodiments will be described in detail with reference to the accompanying drawing. The aspects and features of the present embodiments and methods for achieving the aspects and features will be apparent by referring to the embodiments to be described in detail with reference to the accompanying drawings. However, the present embodiments are not limited to the embodiments disclosed hereinafter, but can be implemented in diverse forms. The matter defined in the description, such as the detailed construction and elements, are only specific details provided to assist those of ordinary skill in the art in a comprehensive understanding of the embodiments, and the present embodiments are only defined within the scope of the appended claims. In the entire description of the present embodiments, the same drawing reference numerals are used for the same elements across various figures.

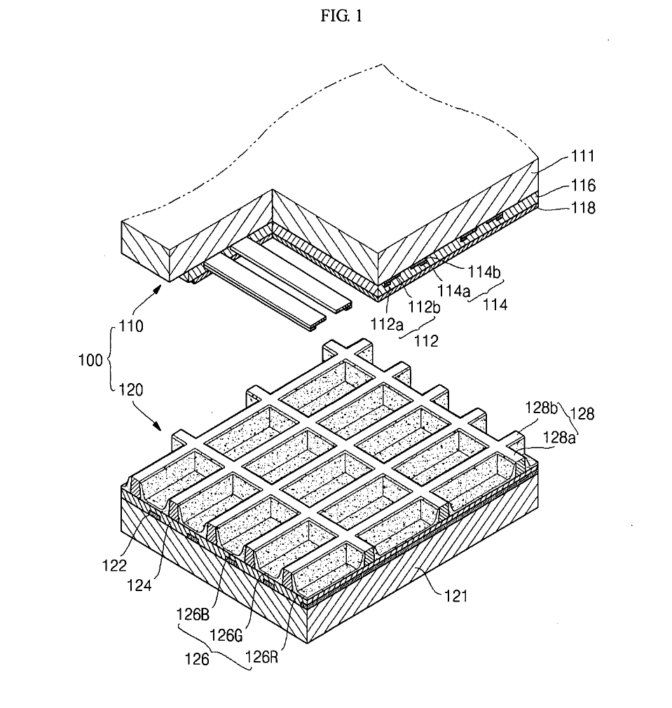

FIG. 1 is a perspective view illustrating a plasma display panel according to the present embodiments.

Referring to FIG. 1, a plasma display panel 100 includes a front panel 110 and a rear panel 120.

The front panel 110 includes a scan electrodes 112, a sustain electrode 114, a first dielectric layer 116, and a protective layer 118.

The scan electrode 112 and the sustain electrode 114 include transparent electrodes 112b and 114b and bus electrodes 112a and 114a, respectively.

The transparent electrodes 112b and 114b are formed along a horizontal direction of the plasma display panel 100 across the front substrate 111. The transparent electrodes 112b and 114b are made of a transparent conductive material such as ITO (Indium-doped Tin Oxide) or ATO (Antimony-doped Tin Oxide) so as to enable a visible ray to be transmitted. The transparent electrodes 112b and 114b are formed to have a thickness of from about 300 to about 1000 nm (e.g., about 700 nm) and the thickness of the transparent electrodes 112b and 114b can be changed according to structure of the plasma display panel and driving condition.

Bus electrodes 112a and 114a are formed in parallel with the transparent electrodes 112b and 114b on the transparent electrodes 112b and 114b and electrically coupled to the transparent electrodes 112b and 114b. The bus electrodes 112a and 114a are formed of a conductive material having good conductivity to compensate low electric conductivity of the transparent electrodes 112b and 114b. For example, the bus electrodes 112a and 114a can be formed with an inorganic compound including Cr—Cu—Cr or Ag having a from about 60 to about 80 μm line width and a from about 3 to about 7 μm thickness as main ingredient. Meanwhile, the bus electrodes 112a and 114a can be black-colored to prevent reflection of external light.

A first dielectric layer 116 is formed to bury a scan electrodes 112 and a sustain electrode 114 in the front substrate 111. In discharge, the first dielectric layer 116 prevents an electric current from flowing directly between the scan electrode 112 and the sustain electrode 114 and prevents damage of the scan electrode 112 and the sustain electrode 114 by a direct collision of a positive ion (+) and a negative ion (−) to the scan electrode 112 and the sustain electrode 114. Also, the first dielectric layer 116 accumulates a wall charge by inducing an electric charge. For example, PbO, B₂O₃, and SiO₂ and the like are used as the first dielectric layer 116.

A protective layer 118 is formed on the first dielectric layer 116. The protective layer 118 makes the discharge easy by increasing the emission of the second electron in the discharge. Also, the protective layer 118 protects a surface of the first dielectric layer 116, thereby preventing reduction of life span of the scan electrode 112 and the sustain electrode 114. The protective layer 118 should be made of a material having a high transmittance, a sputtering characteristic, a low discharge voltage, a wide memory margin and a stability of driving voltage. For example, the protective layer 118 can be made from magnesium oxide (MgO).

The rear panel 120 includes an address electrode 122, a second dielectric layer 124, a barrier rib 128 and a phosphor layer 126, all of which are sequentially formed on the rear substrate 121.

The address electrode 122 is formed on the rear substrate 121 in a direction that it is intersected with the scan electrode 112 and the sustain electrode 114.

The second dielectric layer 124 is formed on the rear substrate 121 so as to bury the address electrode 122. The second dielectric layer 124 prevents damage of the address electrode 122 by a collision of a positive ion (+) or a negative ion (−) to the address electrode 122. Also, the second dielectric layer 124 accumulates a wall charge by inducing an electric charge. For example, PbO, B₂O₃, and SiO₂ and the like are used as the first dielectric layer 116.

The barrier rib 128 divides a discharge space on the second dielectric layer 124 so as to form discharge cells. The barrier rib 128 maintains distance between the front panel 110 and the rear panel 120, thereby preventing cross-talk between discharge cells. The barrier rib 128 is made of, for example, PbO, B₂O₃, SiO₂, Al₂O₃ and the like, and for example, K₂O, BaO, ZnO and the like can be used as an additive.

The barrier rib 128 can use a matrix type barrier rib, which has a horizontal barrier rib 128a and a vertical barrier rib 128b, but the present embodiments are not limited thereto. The barrier rib 128 may be a stripe type barrier rib that extends along a horizontal direction of the plasma display panel, and the barrier rib 128 can be a barrier rib having a section of a polygon such as a hexagon and an octagon, a circle or an ellipse, for example.

A plurality of phosphor layers 126R, 126G and 126B in red (R), green (G), and blue (B) is formed on one side of the barrier rib 128 and the second dielectric layer 124 between barrier ribs 128. The phosphor layer 126 absorbs ultraviolet rays generated by the discharge and generates a visible ray.

After the front panel 110 and the rear panel 120 are attached to each other and air inside the plasma display panel is fully exhausted, a proper amount of discharge gas is filled in the plasma display panel to increase efficiency of discharge. A mixture gas such as Ne—Xe, He—Xe, and He—Ne—Xe, for example, can be used as the discharge gas. For example, Xe of about 11%, He of about 35%, and Ne of about 54% are used as the composition of discharge gas. Pressure of the discharge gas is from about 360 to about 500 Torr and the pressure of gas can be changed according to structure of the panel and driving condition.

As such, the plasma display panel according to one exemplary embodiment is expressed by Equation 1

0.5≦S_{T}/S_{C}≦0.83 Eq. 1

(wherein S_{T}=S_{E}−S_{B})

where S_{C} indicates an upper opening area of the discharge cell surrounded by the barrier rib 128, S_{E} indicates an area of the transparent electrodes 112b and 114b in each discharge cell, S_{B} indicates an area of the bus electrodes 112a and 114a in each discharge cell, S_{T} indicates a net area of the transparent electrodes 112b and 114b where the visible ray can be transmitted by being not overlapped with the bus electrode 112a and 114a among the whole area of the transparent electrode 112b and 114b.

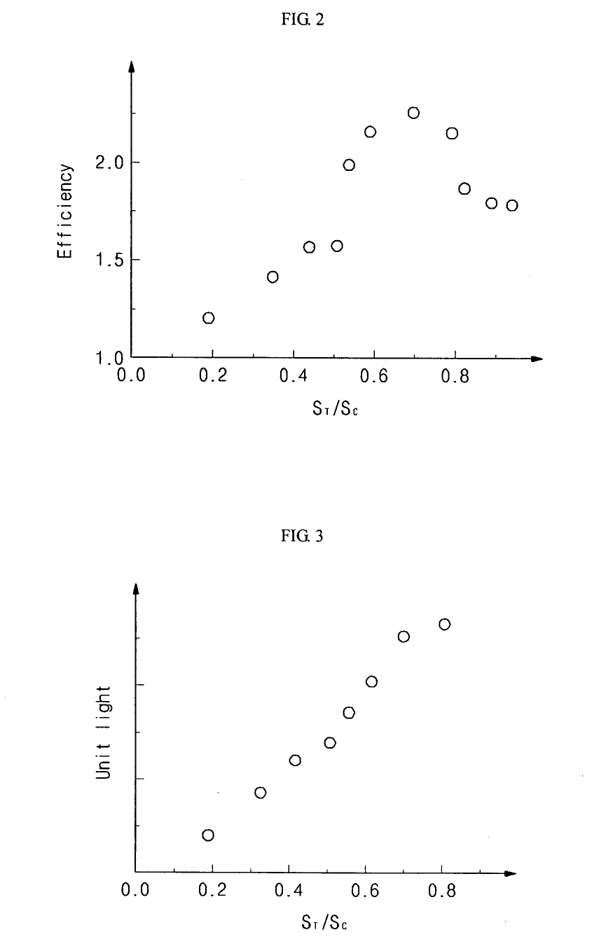

If the Equation 1 is satisfied, efficiency, i.e., a ratio of the brightness (L) against a power (W) supplied to the plasma display panel of FIG. 1, is increased. As illustrated in FIG. 2, in the case where the ratio of the net area (S_{T}) of the transparent electrode 112b and 114b against an area (S_{C}) of the discharge cell is less than 0.51 and more than 0.83, light efficiency is less than 0.175. Meanwhile, in the case where the ratio of the net area (S_{T}) of the transparent electrode 112b and 114b against the area (S_{C}) of the discharge cell is 0.51 to 0.83, the light efficiency is more than 0.175 and is relatively high.

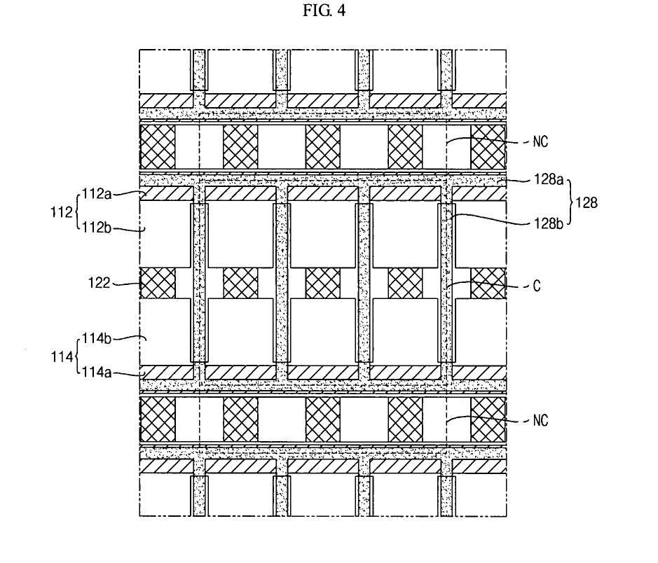

If the Equation 1 is satisfied, as illustrated in FIG. 3, the unit light is increased more than in the case where the ratio of the net area (S_{T}) of the transparent electrode 112b and 114b against the area (S_{C}) of the discharge cell is less than 0.5, thereby allowing the image quality of low grey level to be deteriorated.

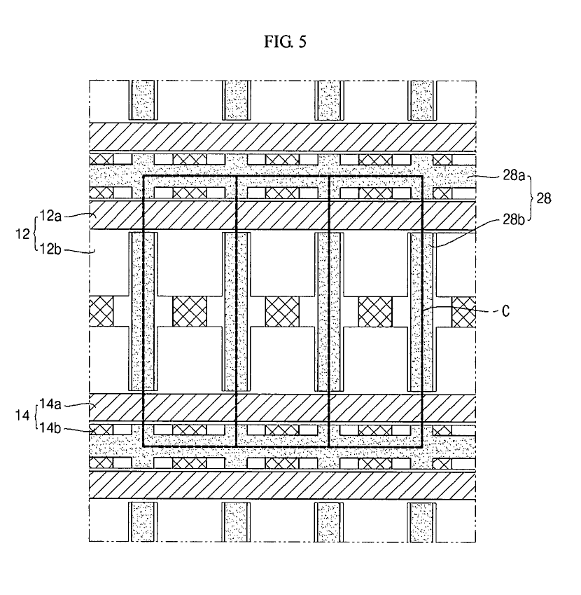

FIG. 4 is a plain view illustrating a plasma display panel according to another exemplary embodiment.

The plasma display panel shown in FIG. 4 has the same constitutions as those of the plasma display panel shown in FIG. 1, except that the barrier rib 128 has a double barrier rib structure. Accordingly, the explanation for the same constitution will be omitted.

The barrier rib 128 includes a horizontal barrier rib 128a and a vertical barrier rib 128b that intersect to each other.

The vertical barrier rib 128b is formed in parallel with an address electrode 122 and between the discharge cells (C) adjacent to left and right direction. Accordingly, the adjacent discharge cells (C) share the vertical barrier lib 128b.

The horizontal barrier rib 128a overlaps with the bus electrodes 112a and 114a in parallel to the bus electrodes 112a and 114a. The horizontal barrier rib 128a is formed to enable a non-discharge cell (NC) to exist in an upper part and a lower part of the discharge cells (C) adjacent to upper and lower direction, where real discharge does not occur in the non-discharge cell (NC). The non-discharge cell (NC) is used as an exhaust passage to improve the exhaust efficiency. Like this, the adjacent discharge cells (C), adjacent to the upper and lower direction, do not share the horizontal barrier rib 128a with each other and thus form the structure of the double barrier rib.

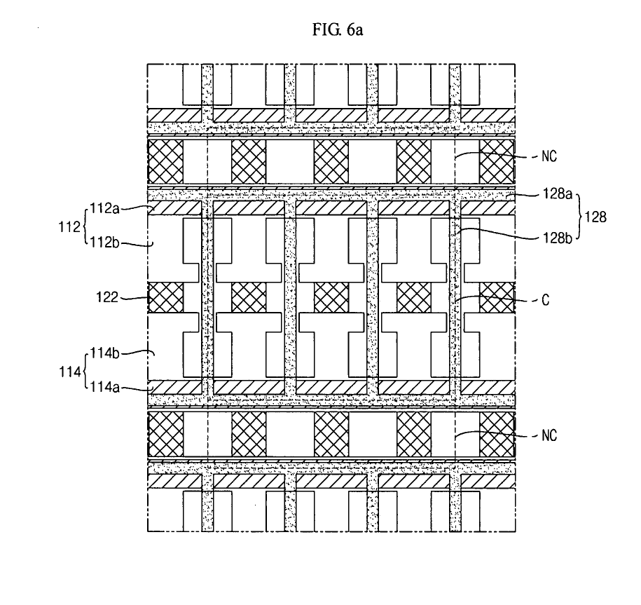

Meanwhile, length and width of each element in the plasma display panel shown in FIG. 4 is the same as those of the plasma display panel shown in FIG. 5 except for the area of discharge cells (C) surrounded by a barrier rib 128 as compared to the plasma display panel, wherein the discharge cells adjacent to the left and right direction share the vertical barrier rib 28b and the discharge cells adjacent to the upper and lower direction share the horizontal barrier rib 28a, as shown in FIG. 5. Accordingly, the ratio of the net area of the transparent electrode 112b and 114b that does not overlap with the bus electrodes 112a and 114a against the area of the discharge cell (C) of the plasma display panel shown in FIG. 4 is about 51%. On the other hand, the ratio of the net area of the transparent electrodes 12b and 14b overlapping with the bus electrodes 12a and 14a against the area of the discharge cell (C) of the plasma display panel shown in FIG. 5 is about 37%. In this case, as shown in table 1, brightness, color temperature, and power consumption of the plasma display panel shown in FIG. 4 is relatively better than those of the plasma display panel shown in FIG. 5.

TABLE 1

| | | PDP(Plasma Display | PDP of |
|---|---|---|---|
| Condition | | Panel) of FIG. 5 | FIG. 4 |
| Full | Brightness(cd/m²) | 174~182 | 180~183 |
| White | Color temperature (° C.) | 7283 | 8362 |
| | Consumption power (W) | 469 | 406 |

| | | |
|---|---|---|
| Unit light (cd/m²) | 4.17 | 3.87 |

Also, if a plasma display panel having a relatively high unit light by satisfying Equation 1 applies the double barrier rib structure like the plasma display panel shown in FIG. 4, then the plasma display panel having the relatively high unit light has a lower unit light as compared to the plasma display panel that does not satisfy the Equation 1 as shown in FIG. 5. Accordingly, the plasma display panel using the double barrier rib and satisfying the Equation 1 improves light efficiency as well as lowers the unit light, thereby allowing display ability of low grey level to be improved.

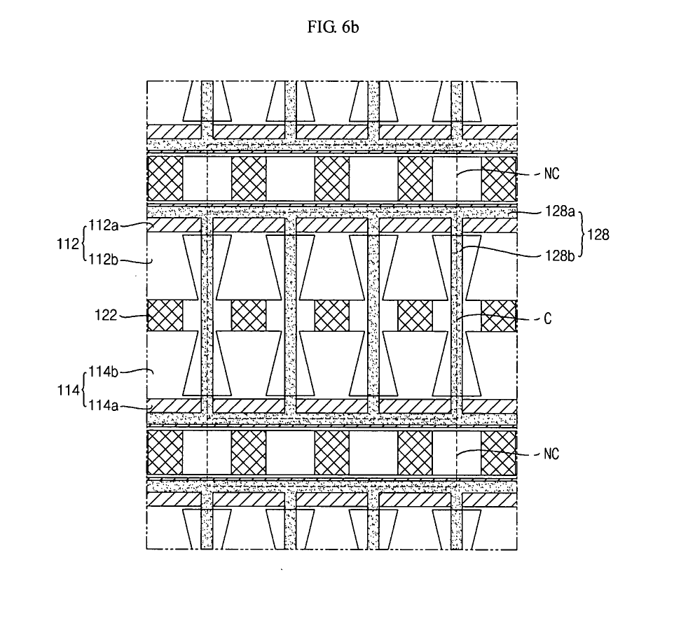

Meanwhile, the transparent electrodes 112b and 114b of the plasma display panel protrude in a plate shape of FIG. 1 and a rectangular shape of FIG. 4, but the present embodiments are not limited thereto. The transparent electrodes 112b and 114b of the plasma display panel may be formed to protrude to discharge space as “T” shape as shown in FIG. 6a or to discharge space as a trapezoid shape as shown in FIG. 6b.

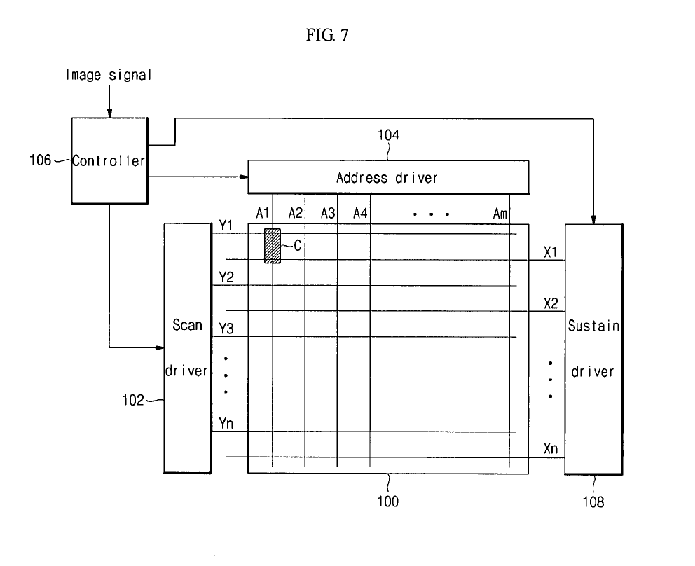

Like this, the plasma display panels according to the present embodiments are driven by a driving apparatus shown in FIG. 7.

The driving apparatus of the plasma display panel shown in FIG. 7 includes an address driver 104 for supplying data to address electrodes (A1 or Am) of the plasma display panel 100, a scan driver 102 for driving scan electrodes (Y1 or Yn), a sustain driver 108 for driving sustain electrodes (X1 or Xn) and a controller 106 for controlling each of drivers 102, 104 and 108.

The controller 106 receives a vertical/horizontal synch signal and generates an address control signal, a scan control signal, and a sustain control signal that are required for each of the drivers 102, 104 and 108. The controller 106 controls each of the drivers 102, 104 and 108 by supplying the generated control signals to the corresponding drivers 102, 104 and 108.

The controller 106 is also driven by dividing one frame into a plurality of sub-fields and each sub-field includes a reset period, an address period, and a sustain period according to the change of time. The controller 106 determines a load factor of a image signal inputted for one frame and APC (Auto Power Control) level corresponding to the load factor so as to decide the total number of the sustain pulses, and then assigns the total number of the decided sustain pulses to the plurality of the sub-fields. The controller 106 can assign the sustain pulses to the plurality of the sub-fields so that the number of the sustain pulse assigned to each sub-field is in proportion to weight value of the corresponding sub-field.

The address driver 104 supplies a data signal to each of address electrodes (A1 to Am), where the data signal is a signal for selecting the discharge cell to be displayed in response to the address control signal from the controller 106.

The scan driver 102 applies the driving voltage to scan electrodes (Y1 or Yn) in response to the scan control signal from the controller 106.

The sustain driver 108 applies the driving voltage to the sustain electrodes (X1 or Xn) in response to the sustain control signal from the controller 106.

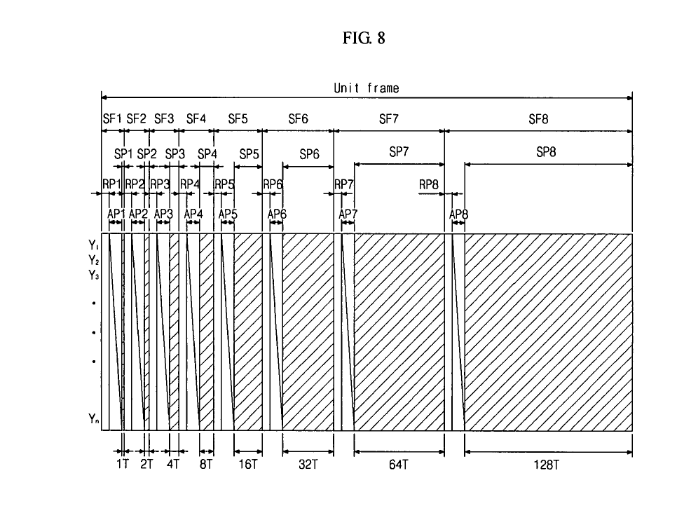

FIG. 8 is a block diagram illustrating a unit frame for displaying an image of the plasma display device according to the present embodiments.

Referring to FIG. 8, the unit frame for displaying the image is divided into eight sub-fields (SF1 or SF8) to express a time-division gray-level. Each sub-field is divided into a reset period (RP1˜RP8), an address period (AP1˜AP8), and a sustain period (SP1˜SP8).

Brightness of the plasma display panel is in proportion to length of the sustain period (SP1˜SP8) for a unit frame. Length of the sustain period (SP1˜SP8) that the unit frame takes is 255T (T is unit time). In this case, for a sustain period (SPn) of the (n)th sub-field (SFn), time corresponding to 2ⁿ is set, respectively. Accordingly, when a sub-filed to be displayed among eight sub-fields is properly selected, all 256 gray-levels including 0 gray-level that is not displayed for every sub-field can be displayed.

Meanwhile, the unit frame is divided into eight sub-fields (SF1˜SF8) and gray-level weight of each sub-field is allocated from the first sub-field (SF1) to the eighth sub-field (SF8) like 1T, 2T . . . 128T, but not limited thereto. Namely, the number of sub-fields for the unit frame can be more or less than eight. The grey level weight for each sub-field can differently allocated according a design specification.

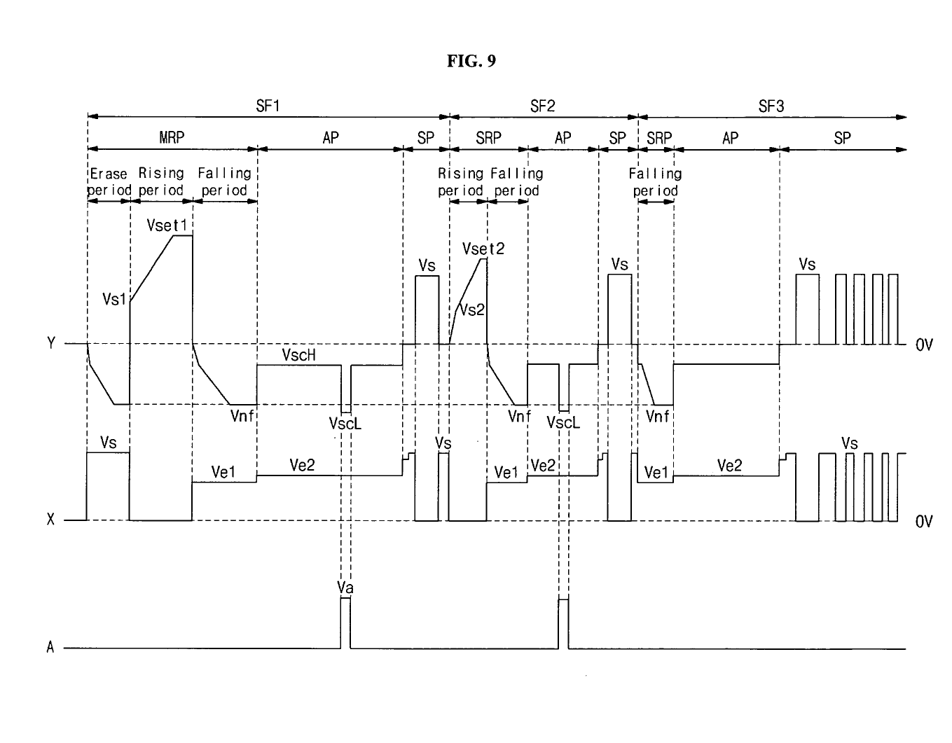

FIG. 9 is a diagram illustrating a driving waveform applied to the first sub-field (SF1) to the third sub-field (SF3) among driving waveforms of the plasma display device according to this embodiment.

Referring to FIG. 9, the first sub-field (SF1) includes a main reset period (MRP), an address period (AP), and a sustain period (SP). A second sub-field (SF2) and a third sub-field (SF3) include a sub reset period (SRP), an address period (AP), and a sustain period (SP), respectively.

The main reset period (MRP) of the first sub-field (SF1) includes an erase period, a rising period and a falling period.

For the erase period of the main reset period (MRP), the voltage of the Y electrode is gradually decreased from a reference voltage (0V in FIG. 9) to a voltage Vnf (or referred to as the fourth voltage) in a state that a voltage Vs is applied to the X electrode. In a previous sub-field of the first sub-field (SF1), a positive (+) wall charge and a negative (−) wall charge are formed on the X electrode and Y electrode, respectively, of the sustain discharged cell. Accordingly, when a waveform, applied to the erase period, is applied to the X electrode and Y electrode of the sustain discharged cell, the wall charges formed on the X electrode and Y electrode of the sustain discharged cell are erased. As a result thereof, the sustain-discharged cells in the previous sub-field of the first sub-filed (SF1) maintains nearly the same wall charge condition as a cell that does not perform the sustain discharge. On the other hand, in FIG. 9, a gradually decreased waveform is applied to the Y electrode as an erase waveform that is applied for the erase period of the first sub-field (SF1). However, the erase waveform may be replaced to a waveform that gradually increase the voltage of the X electrode under the condition that the Y electrode is biased by a reference voltage (0V), and a pulse waveform having a fine width for erasing the wall charge using a short pulse.

Next, for a raising period of the main reset period (MRP), a rising pulse is gradually increased from a voltage Vs1(or referred to as the first voltage) up to a voltage Vset1(or referred to the second voltage) is applied to the Y electrode in a state that the reference voltage (0V) is applied to the X electrode, and the reference voltage (0V) is applied to the A electrode. In this case, a weak reset discharge is generated between the Y electrode and the X electrode, and Y electrode and A electrode. When the reset discharge is generated, a negative (−) wall charge is formed at the Y electrode and a positive (+) wall charge is formed at the X electrode and A electrode. When the voltage of the Y electrode is gradually changed as shown in FIG. 9, the weak discharge is generated at a cell and simultaneously a wall charge is formed so that the sum of a voltage inputted from outside and the wall voltage of the cell can maintain condition of a firing voltage. Since a cell that performs or does not perform the sustain discharge in the previous sub-field should be initialized for the main reset period (MRP) of the first sub-field (SF1), the voltage Vset1 should be a high voltage that enable the discharge to occur in the discharge cell under every condition. Also, the Voltage Vs1 is a voltage lower than the firing voltage between the scan electrode (Y) and the sustain electrode (X).

Further, for a falling period of the main reset period (MRP), a falling pulse for gradually falling from the reference voltage (or referred to the voltage; herein 0V) to the voltage Vnf is applied to Y electrode in a state that the X electrode maintains aVe1 voltage (or referred to as the seventh voltage). If so, the weak discharge is generated between the Y electrode and the X electrode, and between the Y electrode and A electrode while the voltage of Y electrode is decreased, and thus the negative (−) wall charge formed on the scan electrode and the positive (+) wall charge formed on the A electrode and X electrode are erased. Usually, a value of the voltage |Vnf−Ve1 | is set as a value near to the firing voltage between Y electrode and X electrode. As a result thereof, the wall voltage between the Y electrode and the X electrode becomes 0V, thereby preventing misfiring that the cell, which has not been discharged for the address period AP, is discharged for the sustain period SP.

To select a discharge cell that will be “on” for the address period (AP) of the first sub-field, under the condition that X electrode voltage is maintained as a voltage Ve2 (or referred to as the eighth voltage) higher than the voltage Ve1, a scan pulse having a voltage VscL and an address pulse having a voltage Va are inputted to the Y electrode and A electrode, respectively. The Y electrode, which is not selected, is biased by a voltage VscH higher than the voltage VscL and the reference voltage (0V) is applied to the A electrode of a off-cell. The address discharge is generated in the discharge cell that is formed by the A electrode of the voltage Va and Y electrode of the voltage VscL. In this case, the voltage difference (VscL−Ve2) between the Y electrode and the X electrode becomes large and thus stable address discharge can be generated.

To perform the operation for the address period (AP), the scan driver 102 selects at least one of the Y electrodes (Y1˜Yn) that a scan pulse of the voltage VscL is applied. For example, the Y electrode can be selected according to the order that is arranged in a vertical direction in single driving. When one Y electrode is selected, the address driver 104 selects A electrode that the address pulse of the voltage Va is applied among A electrodes (A1˜Am) passing through a cell formed by a corresponding Y electrode. First, the scan pulse of the voltage VscL is applied to the Y electrode of a first row and simultaneously, the address pulse of the voltage Va is applied to the A electrode positioned at on-cell of the first row. As a result thereof, the discharge is generated between the Y electrode of the first row and the A electrode where the voltage Va is applied. Accordingly, the positive (+) wall charge is formed on the Y electrode and the negative (−) wall charge is formed on the A and X electrodes. As the result, a wall voltage (Vwxy) is formed between the Y electrode and the X electrode so that a potential of the Y electrode is higher than that of X electrode. Next, a scan pulse of the voltage VscL is applied to the Y electrode of the second row and simultaneously, the address pulse of the voltage Va is applied to the A electrode positioned on a cell to be displayed among the second row. As a result thereof, as described in the above, the address discharge is generated at the cell that is formed by the A electrode where the voltage Va is applied and the Y electrode of the second row, so as to enable the wall charge to be formed. Likewise, the scanning pulses of the voltage VscL are sequentially applied to the Y electrode on the remaining rows, and simultaneously, the address pulse of the voltage Va is applied to the A electrode positioned at the on-cell so as to form the wall charge.

For the sustain period (SP) of the first sub-field (SF1), the sustain pulse alternately is inputted to the Y electrode and X electrode. By the sustain pulse, a sustain discharge is generated at a cell established as an emitting cell state for the address period (AP) of the first sub-field (SF1). Here, the number of sustain pulses is properly selected according to weight value of the first sub-field (SF1).

Next, a driving waveform applied to the second sub-field (SF2) and the third sub-field (SF3) has the same as those applied to the first sub-field except for the driving waveform applied for the reset period. Accordingly, the overlapped explanation will be omitted.

Referring to FIG. 9, the reset period of the second sub-field (SF2) and the third sub-field (SF3) are a sub reset period (SRP).

In the sub reset period (SRP) of the second sub-field (SF2), a rising pulse gradually increasing from a voltage Vs2(or referred to as the fifth voltage) lower than a Voltage Vs1 to a voltage Vset2 (or referred to the sixth voltage) lower than the voltage Vset1 is applied to the Y electrode, then, a falling pulse that is gradually fallen from the reference voltage (0V) to the voltage Vnf is applied to the Y electrode. Accordingly, in only cell, where the sustain discharged is generated in previous sub-field, the reset discharge is generated. In this case, each width of the rising pulse and the falling pulse that are supplied in the sub reset period (SRP) of the second sub-field (SF2) has a narrower width than that of the rising pulse and the falling pulse that are supplied for the main reset period (MRP) of the first sub-field (SF1).

Therefore, in the sub reset period (SRP) of the second sub-field (SF2), the cell, where the sustain discharge has performed among the discharge cells in the first sub-field (SF1), is initialized by generating the reset discharge. The cell, where the sustain discharge has not performed the in the first sub-field (SF1), maintains the wall discharge state after finishing the main reset period (MRP) of the first sub-field (SF1) and thus is initialized as a non-emission cell state.

In the sub reset period (SRP) of the third sub-field (SF3), the voltage of the Y electrode is not gradually raised and is gradually fallen from the reference voltage (0V) to the voltage Vnf, so that the reset discharge is generated at the only cell where the sustain discharge has performed in each previous sub-field. In this case, the falling pulse supplied for the sub reset period (SRP) of the third sub-field (SF3) has the narrower width than that of a falling pulse supplied for the sub reset period (SRP) of the second sub-field (SF2).

Therefore, in the sub reset period (SRP) of the third sub-field (SF3), the cell, where the sustain discharge has performed among the discharge cells in the second sub-field (SF2), is initialized by generating the reset discharge. The cell, where the sustain discharge has not performed the in the second sub-field (SF2), maintains the wall discharge state after finishing the sub reset period (SRP) of the second sub-field (SF2) and thus is initialized as a non-emission cell state.

Meanwhile, because an operation for a address period (AP) of the second and the third sub-fields (SF2 and SF3) is the same as the address period (AP) of the first sub-field (SF1), the explanation is omitted. The proper number of sustain discharge pulses is set according to weight value of a corresponding sub-field for each sustain period (SP) of the second sub-field (SF2) and the third sub-field (SF3).

As described above, the plasma display panel and the apparatus and the method for driving the same have the discharge cell pitch less than about 650 μm, is implemented so that the ratio of the net area of the transparent electrode against the area of the discharge cell satisfies the Equation 1 as well as uses the double barrier rib structure, thereby improving light efficiency and lowering the unit light. Accordingly, low gray-level expression is improved.

The foregoing exemplary embodiments and aspects are merely exemplary and are not to be construed as limiting the present embodiments. The present teaching can be readily applied to other types of devices. Also, the description of the exemplary embodiments is intended to be illustrative, and not to limit the scope of the claims, and many alternatives, modifications, and variations will be apparent to those skilled in the art.

What is claimed is:

1. A plasma display panel, comprising;
a front substrate and a rear substrate opposing each other;
a scan electrode and a sustain electrode formed on the front substrate;
a transparent electrode and a bus electrode;
an address electrode formed on the rear substrate in a direction that intersects with the scan electrode and the sustain electrode; and
a barrier rib arranged in the space between the front substrate and the rear substrate so as to form a plurality of discharge cells,
wherein the ratio of an area (S_{T}) of the transparent electrode configured to transmit light and an area (Sc) of the discharge cell satisfies the equation:
0.5≦S_{T}/S_{C}≦0.83

2. The plasma display panel of claim 1, wherein the area of the transparent electrode does not overlap with the bus electrode.

3. The plasma display panel of claim 1, wherein the barrier rib comprises a vertical barrier rib arranged in parallel with the address electrode and a horizontal barrier rib arranged to a direction orthogonal to the horizontal barrier rib so as to form a non-discharge cell in a space between discharge cells adjacent to an extension direction of the address electrode.

4. The plasma display panel of claim 1, wherein the transparent electrode is formed to have thickness of from about 300 to about 1000 nm.

5. The plasma display panel of claim 1, wherein the transparent electrode comprises at least one of ITO (Indium-doped Tin Oxide) or ATO (Antimony-doped Tin Oxide).

6. The plasma display panel of claim 1, wherein the barrier rib comprises at least one of PbO, B₂O₃, SiO₂, and Al₂O₃.

7. The plasma display panel of claim 6, wherein at least one of K₂O, BaO, and ZnO is added to the barrier rib.

8. The plasma display panel of claim 1, wherein gas selected from Ne—Xe, He—Xe and He—Ne—Xe, is injected inside the discharge cell and wherein the pressure of the gas is from about 360 to about 500Torr.

9. The plasma display panel of claim 1, wherein the bus electrode is formed with an inorganic compound having Ag of from about 60 to about 80 μm line width and from about 3 to about 7 μm thickness.

10. The plasma display panel of claim 1, wherein the pitch of the discharge cell is less than about 650 μm.

11. An apparatus for driving a plasma display panel comprising a front substrate and a rear substrate that oppose each other; a scan electrode and a sustain electrode formed on the front substrate including a transparent electrode and a bus electrode, an address electrode formed on the rear substrate in a direction that intersects with the scan electrode and the sustain electrode, and a barrier rib that is arranged in the space between the front substrate and the rear substrate so as to form a plurality of discharge cells, the apparatus comprising:
a scan driver configured to drive the scan electrode;
a sustain driver configured to drive the sustain electrode; and
an address driver configured to drive the address electrode,
wherein the ratio of an area (S_{T}) of the transparent electrode configured to transmit light and an area (Sc) of the discharge cell satisfies the equation:
0.5≦S_{T}/S_{C}≦0.83

12. The driving apparatus of claim 11, wherein the area of the transparent electrode does not overlap the bus electrode.

13. The driving apparatus of claim 11, wherein the barrier rib comprises a vertical barrier rib arranged in parallel with the address electrode and a horizontal barrier rib arranged to a direction orthogonal to the horizontal barrier rib so as to form a non-discharge cell in a space between discharge cells adjacent to an extension direction of the address electrode.

14. The driving apparatus of claim 11, wherein pitch of the discharge cells is less than about 650 μm.

15. A method of driving a plasma display panel comprising a front substrate and a rear substrate that oppose each other; a scan electrode and a sustain electrode formed on the front substrate including a transparent electrode and a bus electrode, an address electrode formed on the rear substrate in a direction that intersects with the scan electrode and the sustain electrode, and a barrier rib that is arranged in space between the front substrate and the rear substrate so as to form a plurality of discharge cells, the method comprising:
(a) initializing the plurality of the discharge cells during a reset period of an ith subfield among the plurality of the sub-fields; wherein i is natural number;
(b) selecting an emitting cell among the plurality of the discharge cells during an address period of the ith subfield; and
(c) performing sustain discharge of the emitting cell during a sustain period of the ith subfield,
wherein the ratio of an area (S_{T}) of the transparent electrode configured to transmit and an area (Sc) of the discharge cell satisfies the equation:
0.5≦S_{T}/S_{C}≦0.83

16. The driving method of claim 15, wherein (a) comprises: applying a rising pulse gradually rising from a first voltage to a second voltage to the scan electrode; and applying a falling pulse gradually falling from a third voltage to a forth voltage to the scan electrode.

17. The driving method of claim 16, further comprising: during the reset period of a (i+1)th sub-field subsequent to the ith sub-field, applying a rising pulse gradually rising from a fifth voltage lower than the first voltage to a sixth voltage lower than the second voltage to the scan electrode, and applying the falling pulse gradually falling from the third voltage to the fourth voltage to the scan electrode.

18. The driving method of claim 17, further comprising, during the reset period of a (i+2)th sub-field subsequent to the (i+1)th sub-field, applying the falling pulse gradually falling from the third voltage to the fourth voltage to the scan electrode.

19. The driving method of claim 18, wherein the falling pulse of the ith sub-field is wider than the falling pulse of the (i+1)th sub-field and the falling pulse of the (i+1)th sub-field is wider than the falling pulse of the (i+2)th sub-field.

20. The driving method of claim 18, further comprising:
maintaining the sustain electrode at a seventh voltage during the reset period when the falling pulse is applied; and
maintaining the sustain electrode at an eighth voltage that is higher than the seventh voltage during the address period.
